(19) United States
(12) Patent Application Publication
(10) Pub. No.: US 2015/0304189 A1
(43) Pub. Date: Oct. 22, 2015

(54) A NETWORK CABLE AND AN ELECTRONIC SYSTEM FOR THE LOCALIZATION OF AT LEAST ONE ELECTRIC/ELECTRONIC DEVICE INSIDE AT LEAST ONE BUILDING

(71) Applicant: K-ABLE S.R.L., Sesto San Giovanni (MI) (IT)

(72) Inventors: Flavio BARNA, Concorezzo (MB) (IT); Stefano Emilio GALLI, Cesano Maderno (MB) (IT)

(73) Assignee: K-ABLE S.R.L., Sesto San Giovanni (MI) (IT)

(21) Appl. No.: 14/437,720

(22) PCT Filed: Oct. 8, 2013
(86) PCT No.: PCT/IB2013/059210

§ 371 Date: Apr. 22, 2015

(30) Foreign Application Priority Data
Oct. 30, 2012 (IT) MI2012A 001850

(51) Int. Cl. H04L 12/26; H04B 3/54; H04L 12/24

(52) U.S. Cl. CPC H04L 43/0811; H04L 41/12; H04B 3/542; H04L 41/0816

(57) ABSTRACT

The present invention refers to a network cable and to an electronic system for the localization of at least one electric/electronic device inside at least one building in which the network cable is arranged to connect the at least one electric/electronic device to a port of a telecommunication network wherein the network port is equipped with means for the storage and delivery of data relating to the position and identity of the port, the network cable having a localization module configured for receiving the data relating to the position and identity of the port from the data storage and delivery means, identifying the at least one electric/electronic device and assigning a localization to the electric/electronic device identified by association of the data received.

The present invention refers to a network cable and to an electronic system for the localization of at least one electric/electronic device inside at least one building.

Nowadays, in both the public and private sectors, it is always more necessary to manage and monitor company resources, for example the electric/electronic devices like personal computers, machinery and so on.

Such electric/electronic devices are generally connected, through network cables commonly known, to at least one telecommunication network, like for example the LAN network of a building or the internet network. The electric/electronic devices that are connected to the aforementioned telecommunication networks can be identified through an identification code like the MAC address (Media Access Control).

The identification of the devices connected to the telecommunication network, however, is not sufficient in order to ensure effective monitoring thereof, since it is firstly essential to locate the devices inside the structures of the company that generally comprise at least one building.

It is sufficient to consider the case of a hospital, in which it is essential to know, in real time, the position of the different diagnostic or therapeutic equipment inside the buildings that are part of the hospital itself; indeed, with a rapid and accurate localization, it is possible to tackle situations of emergency which, in a context like that of a hospital, can occur very often.

Currently, in order to locate the electric/electronic devices connected to one same network, in the network it is known to use a plurality of switching apparatuses, commonly called switches, which are configured to identify the devices that are connected through the MAC address and plot a map of the logic connections between them.

For such a purpose, it is known to provide each switch with a storage unit in which, not only the configuration data of the switching apparatus, but also the identification data and the MAC addresses of all the electric/electronic devices connected to the switch itself, are stored.

Such storage units have, therefore, a complex structure and management, making the aforementioned switching apparatuses not simple to configure and costly to maintain.

The purpose of the present invention is that of avoiding the aforementioned drawbacks and in particular that of devising a network cable and an electronic system that is capable of locating at least one electric/electronic device inside at least one building in a quick and simple manner.

This and other purposes according to the present invention are achieved by making a network cable and an electronic system as outlined in the independent claims 1 and 9.

Further characteristics of the network cable and of the electronic system are object of the dependent claims. The characteristics and the advantages of a network cable and of an electronic system according to the present invention shall become clearer from the following description, given as an example and not for limiting purposes, with reference to the attached schematic drawings, in which:

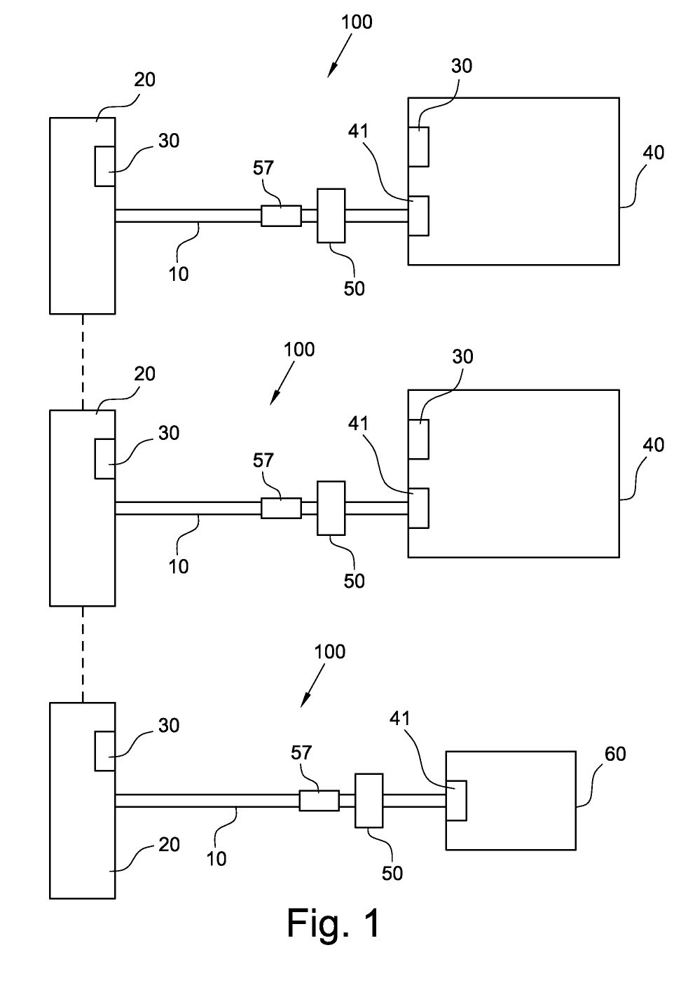

FIG. 1 is a block diagram representative of an electronic system for the localization of at least one electric/electronic device inside at least one building according to the present invention;

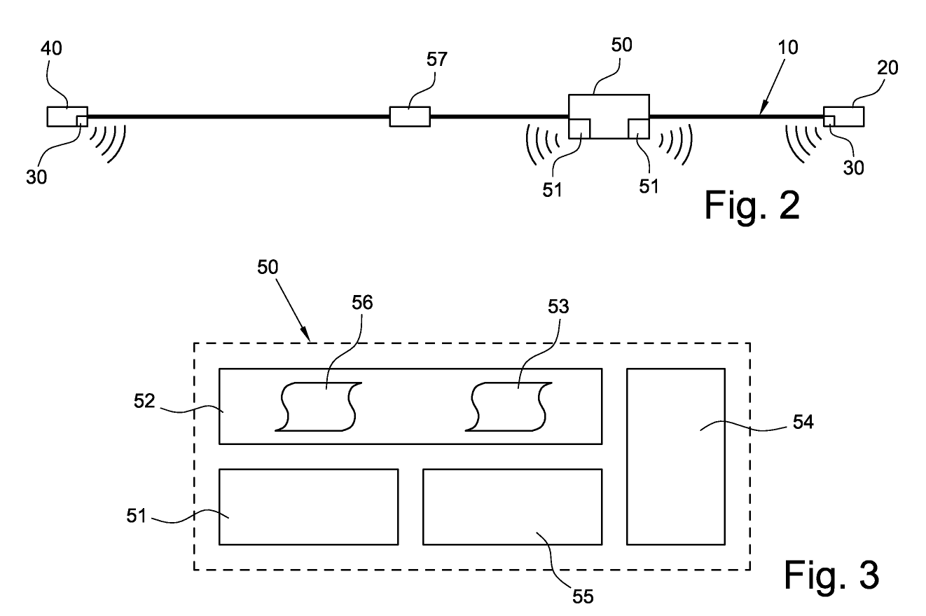

FIG. 2 is a schematic view of a network cable for the localization of at least one electric/electronic device inside at least one building according to the present invention;

FIG. 3 is a schematic view of a localization module comprised in the network cable of FIG. 2.

With reference to the figures, these show an electronic system for the localization of at least one electric/electronic device 40 inside at least one building, wholly indicated with reference numeral 100.

The at least one building comprises a plurality of ports 20 of a telecommunication network, to which it is possible to connect the electric/electronic devices 40. The telecommunication network is for example a LAN network or an IP network.

Although such network ports 20 can belong to different buildings, hereafter, in order to simplify the description, we shall refer to the case in which such ports 20 are installed in a single building.

The electric/electronic devices 40 can be for example personal computers, workstations, laboratory apparatuses or hospital apparatuses and so on. In any case such electric/electronic devices 40 are provided with a connection port 41 through which it is possible to connect them to the network ports 20, by using a suitable connection cable. Every connection port 41 is provided with an, identification code, like for example the MAC address.

The electronic system 100 comprises first means for the storage and delivery of data 30.

Such first storage and delivery means 30 can be associated with at least one network port 20 of the aforementioned plurality of ports. In such a case, the data stored in such first storage and delivery means 30 are data relating to the position and identity of the network port 20 to which they are associated. For example, such data can specify an identification code of the predetermined network port 20, the identification number of the room of the building where such a port is installed.

The first data storage and delivery means 30 can moreover be associated with at least one of the electric/electronic devices 40 to be connected to the network ports 20. In such a case, the data stored in such a first storage and delivery means 30 are identification data of the relative electric/electronic devices. For example, such identification data can be a predetermined identification code.

Preferably, the first data storage and delivery means comprise an RFID label comprising at least one storage unit and a transponder for transceiving wireless data.

According to the present invention, the electronic system 100 comprises at least one network cable 10 for the localization of the at least one electric/electronic device 40 inside at least one building.

Such a network cable 10, equipped with connectors, is arranged to connect the at least one electric/electronic device 40 to a network port 20 inside the at least one building.

In particular, the network cable is preferably an ethernet cable in accordance with standard IEEE 802.3 provided with connectors of the per se known RJ45 type.

The network cable 10, according to the present invention, comprises a localization module 50 that is configured for receiving data relating to the position and identification of the port from the first data storage and delivery means 30, identifying the at least one electric/electronic device 40 and assigning a location to such an electric/electronic device 40 identified by association of the data received. Such a localization module 50 is preferably installed at the cable connectors.

Preferably, the localization module 50 comprises means for wireless receiving 51 the data relating to the position and identity of the network port 20 from the first storage and delivery means 30.

In the case in which such first storage and delivery means 30 associated with the network port 20 and/or with the device 40 are an RFID label, the wireless reception means 51 comprise at least one device for reading RFID labels.

In any case, the localization module 50 comprises an electronic processing and control unit 52, for example a microprocessor, which is connected to the wireless reception means 51 and comprises first software means 53, for example firmware, configured for locating the at least one electric/electronic device 40 on the basis of the data received by the wireless reception means 51 themselves.

Such an electronic processing and control unit 52 is preferably capable of identifying the electric/electronic device 40 by reading the identification code that is associated with the corresponding connection port 41.

Once the electric/electronic device 40 connected to one end of the network cable 10 has been identified, the electronic processing and control unit 52 associates the data relating to the position and identity of the port 20 connected to the other end of the network cable 10, providing a data that represents the localization of the electric/electronic device 40 inside the building.

The localization module comprises a power supply unit that is preferably arranged to receive an electric power supply signal that is transmitted through the network cable 10, for example through the Power over Ethernet or POE protocol.

As a first alternative or in addition, the network cable 10 can comprise a battery (not illustrated) for electrically supplying the power supply unit 54.

As a second alternative or in addition, the power supply unit can be arranged to receive electric energy from a source of electric current outside the network cable 10.

In any case, the power supply unit 54 is associated with the electronic processing and control unit 52 and to the wireless reception means 51, so as to supply them electrically.

Preferably, the electronic processing and control unit 52 is arranged to be configured remotely.

In such a case, the electronic system 100 comprises a remote central processing and control unit 60 that is arranged to receive an informative signal from the network cable 10 and for remote configuring the network cable itself.

In particular, the remote central processing and control unit 60 is capable of connecting to the processing and control unit 52 so as to configure the first software means 53.

Such a remote central processing and control unit 60 is for example a server, or a workstation or a personal computer and so on.

In particular, for example, the remote central processing and control unit 60 can set, in the first software means, the IP address of the electronic processing and control unit 52, the IP address of the remote central processing and control unit 60 itself, the diagnostic parameters, the alarms to be sent, the data to be stored and so on.

In particular, the remote central processing and control unit 60 can connect to the processing and control unit 52 through a direct cabled connection, or through the telecommunication network to which the network cable 10 is connected, or through a pair of wireless transceiver means (not illustrated), a pair of antennas, associated with the network cable 10 and to the remote central processing and control unit 60.

Preferably, the electronic processing and control unit is configured for monitoring the data traffic that passes on the network cable 10, for example Ethernet or IP traffic, and/or detecting the connection/disconnection events of the electric/electronic device 40 to the network port 20.

In such a case such an electronic processing and control unit 52 comprises second software means 56 for monitoring the traffic data, for example computer programs called sniffers.

Preferably, the remote central processing and control unit 60 is moreover arranged to configure such second software means 56.

Preferably, the electronic processing and control unit is moreover configured for sending an informative signal relative to the data detected to a remote central processing and control unit 60. Such an informative signal can, in particular, be sent with the connection types described above.

Preferably, the localization module 50 comprises a storage unit 55 in which the data relating to the position and identity of the network port 20, and/or the aforementioned data detected by the electronic processing and control unit 52 are stored.

Preferably, the network cable 10 comprises second means 57 for the storage and delivery of identification data of the cable itself, like for example an RFID label.

In such a way, when the network cable 10 is put away, for example in a store/warehouse, an RFID labels reading device can detect their presence and send such information to the remote central processing and control unit 60. Therefore, also the network cable 10 can be easily tracked and localized.

Preferably, the localization module 50 comprises time synchronization means (not illustrated), like for example an SNTP synchronizer.

In such a way, the first software means 53 are capable of correlating the data relating to the position of an electric/electronic device at the time instant in which such a position is detected.

The operation of the electronic system 100 and of the network cable 10 is as follows.

We shall consider as an example the case of a company comprising a building provided with a telecommunication network and with relative network ports 20.

Firstly, the first data storage and delivery means 30 are applied at each network port 20 of the building, in particular a plurality of RFID labels, which store data identifying the port and representative of the position thereof inside the building.

Subsequently, a plurality of electric/electronic devices 40 is connected to the aforementioned network ports 20 through the network cable 10 according to the present invention; in particular, such a network cable comprises a device for reading the data stored in the RFID labels.

The remote central processing and control unit 60 is connected to the telecommunication network to which the electric/electronic devices 40 are connected.

Through such a remote central processing and control unit 60, the first 53 and/or second 56 software means of the localization modules 50 of the network cables 10 are configured.

At this stage each network cable 10, through its localization module 50, identifies the electric/electronic device connected to the network cable 10 by means of the MAC address and associates to such a device the data representative of the position of the network port 20 to which the network cable 10 is connected.

The data representative of the position of each device thus obtained is delivered to the remote central processing and control unit 60 which is thus capable of plotting a map of the positions of the devices 40 inside the building.

The network cable 10 can moreover be used to learn information on the state and use of an electric/electronic device that has been given to a generic user, for example an employee that is teleworking or that needs to go to different buildings. In such a case, such a generic user is given an RFID label in which data identifying the user himself are stored, a device, like for example a personal computer, and a network cable 10 according to the present invention.

In such a case, when the user connects the device to the internet through the network cable 10, such a network cable 10 identifies the user by means of the device for reading RFID labels and starts sending data informing of the use of the device to the remote central processing and control unit 60.

The network cable 10, according to the present invention, can be used also in the case in which a clinic must provide a therapeutic treatment remotely through therapeutic machinery connected to the internet and localized for example in a home.

In such a case, the association of the network cable 10 to the RFID label containing the data of the patient makes it possible to give dedicated assistance to the patient himself.

The network cable 10 can moreover be used as a licensed tool for using equipment, software or machinery. In such a case, an authorization code is stored on the RFID label to be associated to the network port 20 that is read by the network cable 10 and sent to the remote central unit 60, for example a server for controlling the licenses. The remote central unit 60 controls the authenticity of the authorization code and authorizes the use of the software or of the machinery object of the license.

From the description made the characteristics of the network cable and of the electronic system object of the present invention are clear, just as the relative advantages are also clear.

Indeed, the presence of the localization module, according to the present invention, makes it possible for there to be an accurate and rapid detection of each device connected to a telecommunication network for example of a company.

Therefore, it is possible to substantially have, in real time, an indication of the position of a device inside a building.

Finally, it is clear, that the network cable and the electronic system thus conceived can undergo numerous modifications and variants, all covered by the invention; moreover, all the details can be replaced by technically equivalent elements. In practice the materials used, as well as the dimensions, can be any according to the technical requirements.

1. A network cable for the localization of at least one electric/electronic device inside at least one building, said network cable being arranged to connect said at least one electric/electronic device to a port of a telecommunication network, wherein said network port is equipped with first means for the storage and delivery of data relating to the position and identity of said port, said network cable comprising a localization module configured for receiving said data relating to the position and identity of said port from said first data storage and delivery means, identifying said at least one electronic/electric device and assigning a localization to said identified electronic/electric device by association of said data received.

2. The network cable according to claim 1, wherein said localization module comprises:
means for wireless receiving said data relating to the position and identity of said port from said first storage and delivery means and/or data for identification of said at least one electronic/electric device;
an electronic processing and control unit connected to said means for wireless receiving, and comprising first software means configured for locating said at least one electronic/electric device on the basis of the data received from said wireless reception means.

3. The network cable according to claim 2, wherein said wireless reception means comprise at least one device for reading RFID labels.

4. The network cable according to claim 1, wherein said localization module comprises a power supply unit arranged to receive an electric supply signal transmitted through said network cable, said power supply unit being associated with said electronic processing and control unit and with said wireless reception means, to supply them electrically.

5. The network cable according to claim 1, wherein said localization module is also configured for monitoring the data traffic passing on said network cable and/or detecting the connection/disconnection events of said electric/electronic device to said network port and sending a corresponding informative signal to a remote central processing and control unit.

6. The network cable according to claim 5, wherein said localization module comprises a storage unit.

7. The network cable according to claim 1, wherein said localization module is arranged to be remotely configured.

8. The network cable according to claim 1, wherein it comprises second means for the storage and delivery of identification data of said network cable.

9. An electronic system for the localization of at least one electric/electronic device inside at least one building, wherein said at least one building comprises a plurality of ports of a telecommunication network, said system comprising:
at least one network cable according to claim 1, for the connection of said electric/electronic device to one of said network ports;
first means for the storage and delivery of data connectable to each network port and/or the electric/electronic devices.

10. The electronic localization system according to claim 9, further comprising a remote central processing and control unit arranged to receive an informative signal from said network cable and remote configuring said network cable.
